(19) United States
(12) Patent Application Publication
(10) Pub. No.: US 2012/0229476 A1
(43) Pub. Date: Sep. 13, 2012

(54) PHYSICAL GRAPHICS CARD USE FOR MULTIPLE USER COMPUTING

(76) Inventor: Boris Dogramadgi, Netanya (IL)

(21) Appl. No.: 13/044,979

(22) Filed: Mar. 10, 2011

(51) Int. Cl. G06T 1/00

(52) U.S. Cl. 345/502; 345/520

(57) ABSTRACT

The current invention allows the connection of a plurality of monitors to a single host computer, allowing the use by a plurality of users without the additional cost and complexity of a terminal server, local area network and thin clients or additional computers for each user. The host computer includes a video card having at least two separate video outputs, each connected to a monitor. Alternatively or additionally, the host includes a plurality of video cards. Each user interacts with a unique session that executes the user's application and displays its results on one of the monitors. The invention disclosed methods for enabling use of one or more physical graphics cards for one or more user sessions within a single computer. The invention disclosed methods to allow the assignment of a separate video output to each user by using video a plurality of drivers. In some embodiments, a video synchronizer is used by all graphics functions and allowing direct invocation of video card commands to synchronize commands to said video card.

### FIELD OF THE INVENTION

The current invention allows the connection of a plurality of monitors to a single computer, allowing the use by a plurality of users without the additional cost and complexity of a terminal server, local area network and thin clients or additional computers for each user.

### BACKGROUND

Studies indicate that under normal use, much of the processing power of current personal computers is unused. Many suggestions have been made to use this excess processing power for other purposes including offline processing and use of networked computers for code breaking and analysis of radio signals for patterns (e.g. Search for Extra-Terrestrial Intelligence, SETI@home). One such use is to support multiple users on a single personal computer similar to the methods used by Microsoft Terminal Services to support multiple remote users. Normally, support for multiple users is done using separate computing servers (or Terminal Servers) and local systems for input and output (thin clients or low power personal computers may be used for this purpose). In a local environment it is possible to also support multiple users on a single computer with the addition of only peripheral equipment directly connected to the computer.

United States Patent Application 2009/0089815, Method and System for Performing I/O Operations using a Hypervisor, discloses the ability to replace a device driver to allow direct access of hardware

United States Patent Application 2009/0195537, Graphics Remoting Architecture, discloses the ability to use a physical graphics card on a remote server to accelerate the graphics processing for a single session. In distinction to this invention, the invention of 2009/0195537 is limited to use in client server architectures where the session is executing on the remove server and a client is executing on a local computer such as a thin client or a personal computer.

### SUMMARY OF THE EMBODIMENTS

The current invention allows the connection of a plurality of monitors to a single host computer, allowing the use by a plurality of users without the additional cost and complexity of a terminal server, local area network and thin clients or additional computers for each user. The host computer includes a video card having at least two separate video outputs, each connected to a monitor. Alternatively or additionally, the host includes a plurality of video cards. Each user interacts with a unique session that executes the user's application and displays its results on one of the monitors. The invention disclosed methods for enabling use of one or more physical graphics cards for one or more user sessions within a single computer. The invention disclosed methods to allow the

It is an aspect of the current invention to provide a computer system comprising: a single host computer capable of concurrently executing at least a first session having a first application interacting with a first user and a second session having a second application interacting with a second application; and at least a first monitor displaying output of the first application and used by the first user, and a second monitor displaying output of the second application and used by the second user, wherein the single host computer comprises: at least a first video card, and at least a first video output connected to the first monitor and a second video output connected to the second monitor.

In some embodiments the first session is the primary session or consol session.

In some embodiments the first user is the local user.

In some embodiments the both the first video and the second video output are outputs of the first video card.

In some embodiments the single host further comprises a second video card, wherein: the first video output is an output of the first video card, and the second video output is an output of the second video card.

In some embodiments the single host computer is further capable of concurrently executing at least one additional session having an additional application interacting with an additional user; and an additional monitor displaying output of the additional application and used by the additional user.

In some embodiments at least one of the first or second sessions comprise a safe mode driver receiving graphic data and commands from the respective first or second application and storing video data in a safe mode buffer in the single host; and the first session comprises a viewer, receiving video data from the safe mode buffer; and communicating data to the second video card using a video driver.

In some embodiments the second session comprises a safe mode driver receiving graphic data and commands from the a second application and storing video data in a safe mode buffer in the single host; and the first session comprises a viewer, receiving video data from the safe mode buffer; and communicating data to the second video card using a video driver.

In some embodiments at least one of the first and second sessions comprise a native video driver receiving graphic data and commands from the respective first or second application and communicating data to the first video card.

In some embodiments the first session comprises a native video driver receiving graphic data and commands from the first application and communicating data to the first video card.

In some embodiments the second session comprises a safe mode driver receiving graphic data and commands from the a second application and storing video data in a first safe mode buffer in the single host; and the third session comprises a safe mode driver receiving graphic data and commands from the a third application and storing video data in a second safe mode buffer in the single host; and the first session comprises a viewer, receiving video data from the first safe mode buffer and the second safe mode buffer; and communicating data to the second video card and the third video card respectively using a video driver.

In some embodiments the single host further comprising a video synchronizer used by all graphics functions and allowing direct invocation of video card commands to synchronize commands to the video card.

In some embodiments each of the sessions is assigned with a unique video output such that video from each session is displayed on one of the displays.

In some embodiments each of the video outputs is on a separate video card.

In some embodiments at least two of the video outputs are on the same video card.

Unless otherwise defined, all technical and scientific terms used herein have the same meaning as commonly understood by one of ordinary skill in the art to which this invention belongs. Although methods and materials similar or equivalent to those described herein can be used in the practice or testing of the present invention, suitable methods and materials are described below. In case of conflict, the patent specification, including definitions, will control. In addition, the materials, methods, and examples are illustrative only and not intended to be limiting.

### BRIEF DESCRIPTION OF THE FIGURES

Some embodiments of the invention are herein described, by way of example only, with reference to the accompanying drawings. With specific reference now to the drawings in detail, it is stressed that the particulars shown are by way of example and for purposes of illustrative discussion of the preferred embodiments of the present invention only, and are presented in the cause of providing what is believed to be the most useful and readily understood description of the principles and conceptual aspects of the invention. In this regard, no attempt is made to show structural details of the invention in more detail than is necessary for a fundamental understanding of the invention, the description taken with the drawings making apparent to those skilled in the art how the several forms of the invention may be embodied in practice.

In the drawings:

FIG. 1 shows a computer system in accordance with one or more exemplary embodiments of the invention demonstrating the use of safe mode video drivers in conjunction with native mode video drivers.

FIG. 2 is a block diagram illustrating a computer system in accordance with one or more exemplary embodiments of the invention demonstrating the use of multiple native mode video drivers.

FIG. 3 is a block diagram illustrating a prior art method of rendering graphics using a virtual device driver on a remote session server with communication of graphics commands to a local client driver.

FIG. 4 is a block diagram illustrating a prior art graphics acceleration method using a physical graphics card in a remote session server with communication of rendered graphics to a local client.

FIG. 5A is a block diagram illustrating a prior art graphics

FIG. 5B is a block diagram illustrating a prior art graphics processing stack for Remote Desktop Protocol (RDP) type sessions.

FIG. 6 is a block diagram illustrating the use of a video synchronizer to allow multiple session use of a single graphics card without conflict in accordance with one or more exemplary embodiments of the invention.

FIG. 7 is a block diagram illustrating the use of multiple physical graphics cards with native drivers in a single host to support multiple sessions in accordance with one or more exemplary embodiments of the invention.

FIG. 8 is a flow diagram illustrating the method of associating sessions and video cards using native mode video drivers in accordance with one or more exemplary embodiments of the invention.

FIG. 9 is a block diagram illustrating the use of multiple physical graphics cards with safe mode drivers in a single host to support multiple sessions in accordance with one or more exemplary embodiments of the invention.

FIG. 10 is a flow diagram illustrating the method of associating sessions and video cards using safe mode video drivers in accordance with one or more exemplary embodiments of the invention.

### DESCRIPTION OF SELECTED EMBODIMENTS

Before explaining at least one embodiment of the invention in detail, it is to be understood that the invention is not necessarily limited in its application to the details set forth in the following description or exemplified by the Examples. The invention is capable of other

The terms “comprises”, “comprising”, “includes”, “including”, and “having” together with their conjugates mean “including but not limited to”.

The term “consisting of” has the same meaning as “including and limited to”.

The term “consisting essentially of” means that the composition, method or structure may include additional ingredients, steps and/or parts, but only if the additional ingredients, steps and/or parts do not materially alter the basic and novel characteristics of the claimed composition, method or structure.

As used herein, the singular form “a”, “an” and “the” include plural references unless the context clearly dictates otherwise. For example, the term “a compound” or “at least one compound” may include a plurality of compounds, including mixtures thereof.

Throughout this application, various embodiments of this invention may be presented in a range format. It should be understood that the description in range format is merely for convenience and brevity and should not be construed as an inflexible limitation on the scope of the invention. Accordingly, the description of a range should be considered to have specifically disclosed all the possible sub-ranges as well as individual numerical values within that range.

It is appreciated that certain features of the invention, which are, for clarity, described in the context of separate embodiments, may also be provided in combination in a single embodiment. Conversely, various features of the invention, which are, for brevity, described in the context

In discussion of the various figures described herein below, like numbers refer to like parts. The drawings are generally not to scale. For clarity, non-essential elements were omitted from some of the drawing.

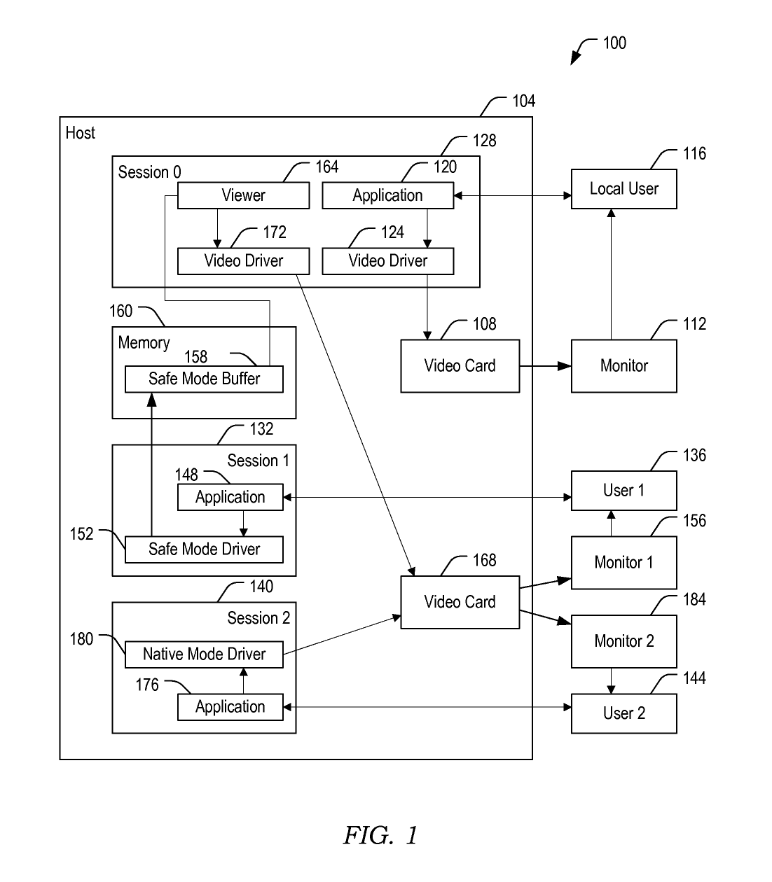

FIG. 1 schematically depicts a computer system 100 in accordance with one or more exemplary embodiments of the invention.

Host computer 104 is configured with a video card 108 and monitor 112 for use by a local user 116. Throughout this document the term video card and graphics card are used interchangeably and refer to any mechanism capable of receiving data and/or commands and providing data and/or commands usable by a device such as a display or monitor 112 to create images. The local user 116 communicates with one or more applications 120. The application 120 uses a video driver 124 to communicate video commands and data to the video card 108 for display on monitor 112. The application 120 and video driver 124 are executed in a session 128, usually identified as session “0”. This session is also commonly identified as the primary session or consol session. The interactive loop from the local user 116 through an application 120, video driver 124, video card 108 and monitor 112 is well know prior art.

In addition, the computer system described contains at least one additional session used to allow additional users to interact with the host

Session “1” (132) is used by user 1 (136) is used for executing application 148. Application 148 is executed in a separate session, session “1” (132) to present the appearance to user 1 (136) that this user has access to a computer separate from the computers used by other users (such as user 2 (140) and the local user 116). Application 148 uses a safe mode driver 152 to display video output on monitor 1 (156) for use by user 1 (136). The term safe mode driver 152 refers to a video driver that does not directly send commands and/or data to a video card but instead renders the commands and/or data into graphics output for display by an application operating in the host session “0” 128.

Safe mode driver 152 writes data to a safe mode buffer 158 in the memory 160 of host 104. A viewer 164 running as an application in session “0” (128) reads the data from the safe mode buffer 158 and communicates the data to a second video card 168 using the appropriate video driver 172. It should be noted that any or none of video card 108 and/or second video card 168 may comprise a single or a dual video output ports, and the depicted case in which video card 108 is connected to a single monitor 112, while second video card 168 is connected to two monitors 156 and 184 is to be viewed as non limiting example. Second video card 168 then renders the display image to be sent to monitor 1 (156) associated with session “1” (132) for use by user 1 (136). The use

Session “2” (140) is used by user 2 (144) to execute application 176. Application 176 is executed in a separate session, session “2” (140) to present the appearance to user 2 (144) that this user has access to a computer separate from the computers used by other users (such as user 1 (136] and the local user 116). Application 176 users a native mode driver 180 to display video output on monitor 2 (184) for use by user 2 (144). The term native mode driver 180 refers to a driver which sends commands and/or data directly or indirectly to the video card for rendering by the video card. In the depicted example, native mode driver 180 communicates directly with the second video card 168 for improved performance and/or to use features of second video card 168 not available through the safe mode driver 152. In many cases the native mode driver 180 may be an unmodified video driver supplied by the manufacturer of the second video card 168. In such cases the native mode driver 180 may be the same driver as is used by the viewer 164 in session “0” (128) to communicate with the second video card 168.

In the depicted embodiment, second card 168 has dual video output port as would be discussed later, and is capable of driving two separate monitors, monitor 1 (156) used by user 1 (136), and monitor 2

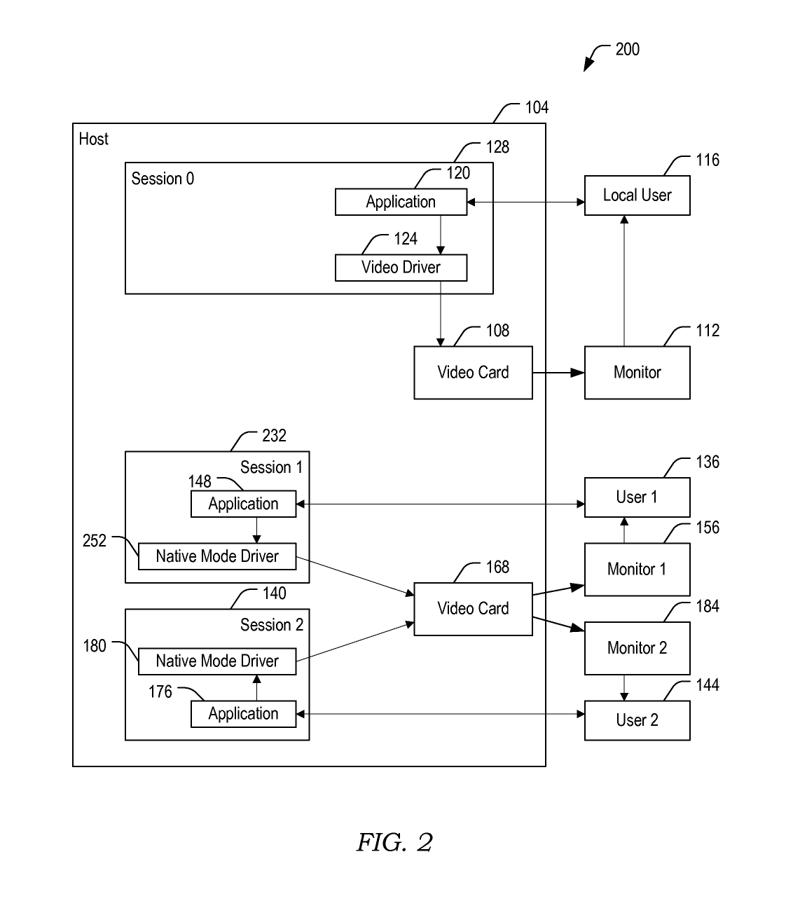

FIG. 2 shows a computer system 200 in accordance with one or more exemplary embodiments of the invention. The embodiment shown in FIG. 2 is similar to the embodiment shown in FIG. 1, but shows the use of multiple native mode drivers 180 and 252 for session “2” (140) and session “1” (232) respectively.

Host computer 104 is configured with a video card 108 and monitor 112 for use by a local user 116. The local user 116 communicates with one or more application 120. The application 120 uses a video driver 124 to communicate video commands and data to the video card 108 for display on monitor 112. The application and video driver are executed in a session 128 usually identified as session “0”. This session is also commonly identified as the primary session or consol session. The interactive loop from the local user 116 through an application 120, video driver 124, video card 108 and monitor 112 is well know prior art.

In addition, the computer system 200 described contains at least one additional session used for allowing an additional user or a plurality of additional users to interact with the host 104. FIG. 2 shows an example in which two such additional sessions: session “1” (232) is used by user 1 (136) which interacts with application 148; and session “2” (140) is used by user 2 (144) which interacts with application 176. In many cases these additional sessions will be created as Remote Desktop Protocol (RDP) sessions but other equivalent methods of creating sessions may be used. It should be noted that in some exemplary embodiments of the current invention, more sessions and users may exists.

Session “2” (140) and the components thereof: native mode

Session “1” (232), using video card 168 also uses a native mode driver 252 to interact with video card 168. Graphics commands generated by native mode driver 252 in response to commands from application 176 are rendered by video car 168 and output to monitor 1 (156) for user 1 (136) using a separate output connection on video card 168.

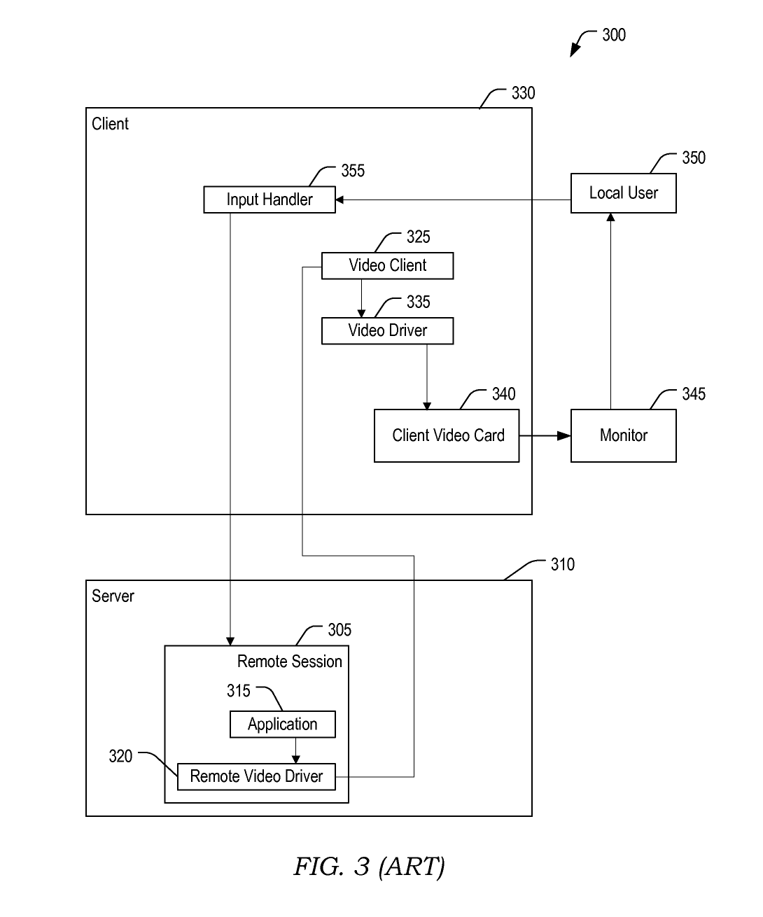

FIG. 3 schematically depicts a block diagram 300 illustrating a prior art method of rendering graphics using a virtual device driver on a remote session server with communication of graphics commands to a local client driver.

The prior art depicted in FIG. 3, use of a remote session 305 executed on a remote server 310. In order to display output from an application 315 running in the remote session 305, a remote video driver 320 is used. The remote video driver 320 accepts commands from application 315 and forwards the commands to a video client 325 executed on the client 330. The video client 325 receives video commands from the remote video driver 320 and invokes the same commands on the local video driver 335 associated with the client video card 340 to display graphical output from application 315 to the local user 350 on monitor 345. While not shown, the components of the client 330 will normally be executing within the session “0” of client 330.

Inputs from the local user 350 are similarly communicated to the remote session 305 through an input handler 355 executed on the client 330. This interaction is shown only to indicate the complete cycle of interaction available to the local user 350 and is not a part of the current

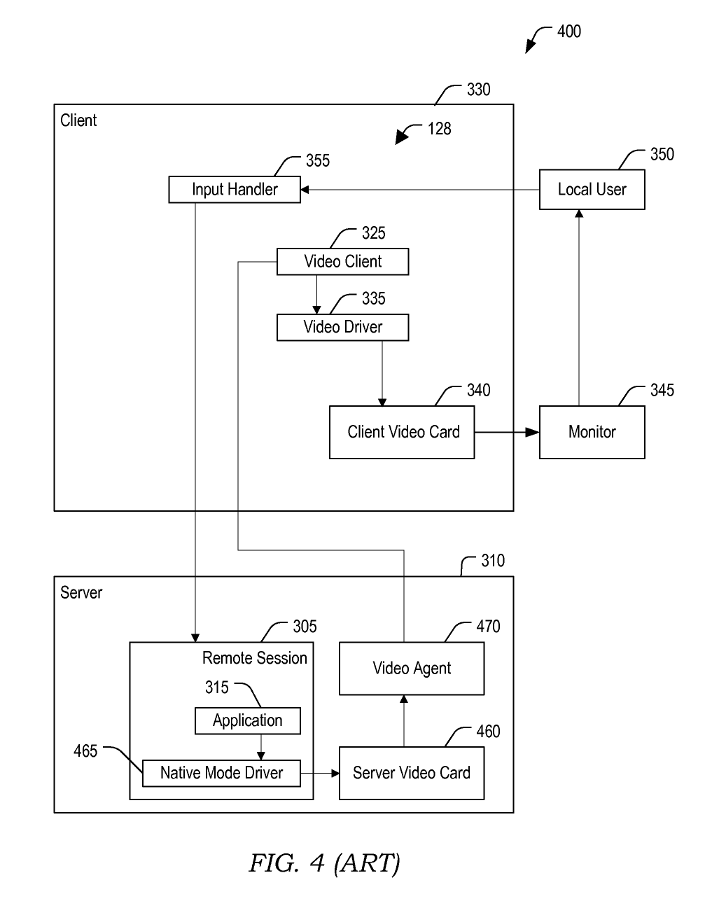

FIG. 4 schematically depicts shows the prior art system 400 that use of a physical graphics card 460 in a server 310 that executes a remote session 305, in order to accelerate graphics or to provide higher quality graphics than can be provided by the method shown in FIG. 3.

The server video card 460 shown in FIG. 4 is an actual, physical, graphics card used to provide high quality and/or high performance graphics capabilities to the remote session 305. In order to use the full capabilities of the server video card 460, the remote session 305 uses a native mode driver 465, normally provided by the manufacturer of the server video card. The output of the server video card 460 is redirected to a video agent 470 that is used for sending the graphics output to the client 330. The video agent 470 commonly operates by reading the frame buffer memory of the server video card 460, compressing the contents of the frame buffer and communicating the compressed contents to the client 330.

The video client 325 executed on the client 330 receives the contents of the server video card 460 sent by the video agent 470 and generates commands to video driver 335 that result in the writing of the frame buffer contents to the client video card 340 for display on monitor 345. If the contents sent by the video agent 470 are compressed, the video client 325 decompresses the frame buffer contents before sending the frame buffer contents to video driver 335.

Embodiments of the current invention, uses a similar method of using a native mode driver in a session, to render graphics on a physical video card, but does not require the use of a separate server 310, multiple video cards (340 and 460), a video agent 470 or a video client 325 seen in FIG. 4 of the art.

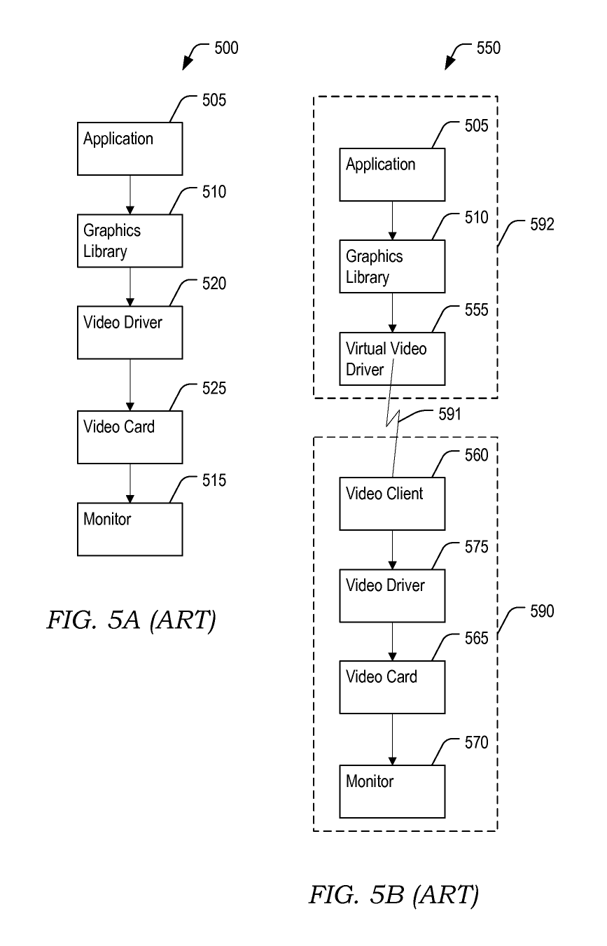

FIGS. 5A and 5B schematically depict prior art arrangements of elements used to display text and graphics to a user.

FIG. 5A schematically depicts a block diagram 500 illustrating a prior art graphics processing stack for normal application processing.

As shown in FIG. 5A, an application 505 that needs to display text and/or graphics to the user will use standardized calls to a graphics library 510 to invoke the process of generating the data necessary to display of the text and/or graphics and the process of using this data to create an image on a monitor 515. The graphics library 510 may be linked to the application 505, but is often present as a separate dynamically linked library (DLL) associated with the application 505 when the application 505 is executed. The graphics library 510 provides general purpose functions usable by applications to invoke the display of text and/or graphics and to control the position, attributes, color, size, font, etc. of the text and/or graphics. In some operating systems the graphics library component may be implemented using several parts, for example a graphics kernel with various libraries providing different application interfaces.

The graphics library 510 will then pass data representing the text and/or graphics to a video driver 520. The video driver 520 provides a standard interface to video hardware, in this case a video card 525. The video driver 520 receives the data from the graphics library in a standard form and maps this data to a form specifically usable by the specific video card present in the host computer. The video driver 520 is often provided by the manufacturer of the video card 525, to allow taking advantage of unique video card capabilities provided by the manufacturer's cards.

The video card 525 receives the data and commands from the

The Monitor 515 receives the bit mapped image and displays the image to the user by modifying the luminosity of individual screen elements. The screen elements may be discreet, commonly termed pixels or may be analog lines such are used in analog television displays.

FIG. 5B schematically depicts a block diagram 550 illustrating a prior art graphics processing stack for Remote Desktop Protocol (RDP) type sessions.

As shown in FIG. 5B a remote desktop session may be created by the use of a session virtual video driver 555 instead of the usual video driver 520 of FIG. 5A. The session virtual video driver 555 receives commands and data from the graphics library 510, but instead of creating commands and data for the local video card 525, it communicates commands and data to a Session video client 560 on a remote computer 590. The session video client 560 on the second host computer 590 creates commands and data for the video card 565 on the remote computer using a video driver 575 in the remote computer 590. As with the video card 525 normally used, the video card 565 in the remote computer renders an image for display, but the display is done by a monitor 570 connected to the remote computer 590.

The communication of the commands and data between the session video driver 555 and the Session video client 560 may be accomplished using any communications protocol 591 as the underlying communications protocol does not modify the commands and data.

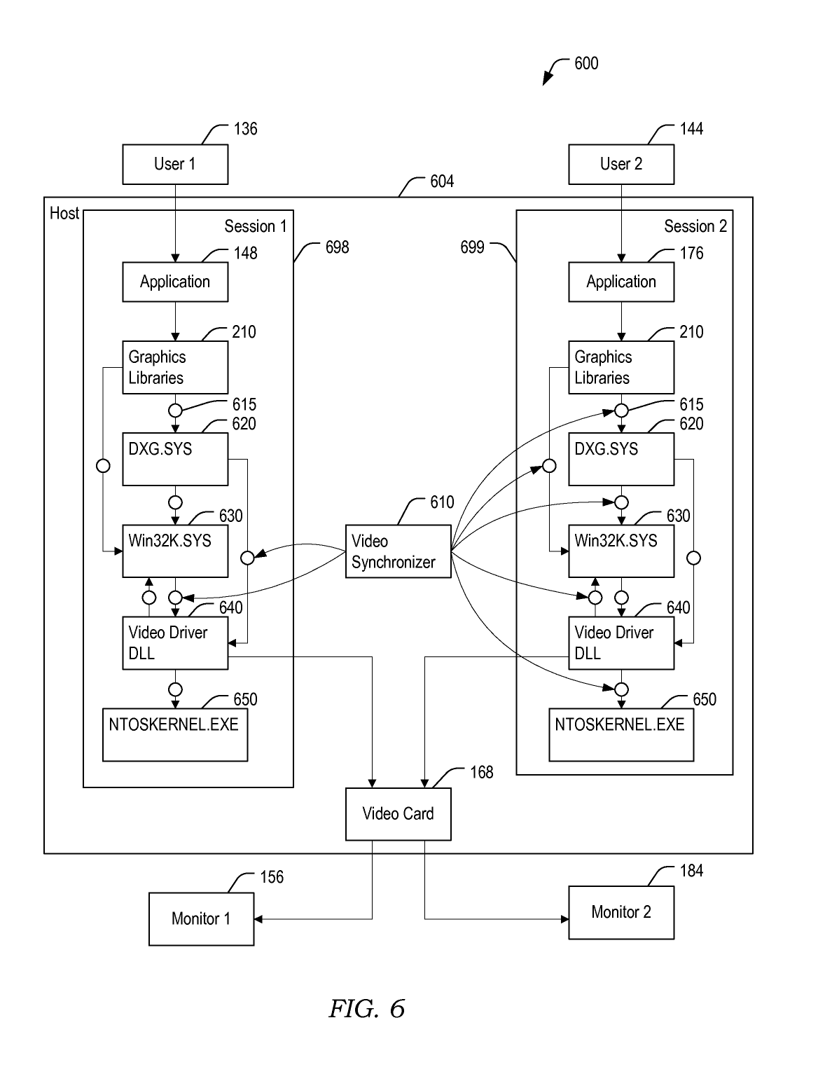

FIG. 6 schematically depicts a block 600 diagram illustrating the use of a video synchronizer to allow multiple sessions to use a single graphics card without conflict, in accordance with one or more exemplary embodiments of the invention.

Normally a video card with multiple output ports is intended to be used to either allow a selection of output formats or to allow a single session to use multiple monitors. For example, a video card may have both S-Video and VGA outputs allowing the a video image to be displayed on a monitor connected to the card using an S-Video cable or to allow the same video image to be displayed on a monitor connected to the video card using a VGA cable. The multiple output formats provides the user with flexibility in purchasing monitors or the ability to use different types of monitors in different locations.

Alternatively, a video card may provide multiple output ports allowing the use of multiple monitors to create a virtual screen comprised of multiple physical monitors. This is commonly referred to a matrix video system.

The current invention is unique in that video cards intended for the above uses are instead used to allow multiple independent outputs to be created from multiple independent sessions such as session “1” (698) used by user “1” (136) and session “2” (699) used by user “2” (144), executing applications 148 and 176, and displayed on monitor “1” (156) and monitor “2” (184) respectively. In order to support this use, the video commands received from separate sessions (698) and 699), and the writing of the commands to the video card 168 are synchronized. In

The method used in the exemplary embodiment of the current invention provides such synchronization through the use of function hooking. Function hooking involves the redirection of function calls from the executable code normally associated with the function to other executable code. Function hooking is easily implemented in operating systems that use common function in shared libraries, commonly known as Dynamic-Link Libraries (DLLs) in the Microsoft Windows operating systems by replacing the standard shared libraries with equivalent libraries implementing additional functionality, or by intercepting the operating system methods used to associate functions required by applications with the corresponding functions in the shared libraries. The interception may consist of replacing the functions required by the application and/or the execution of additional functions before or after the execution of the functions provided by the shared libraries. In the current invention, function hooking is used to provide a synchronization flag, semaphore, critical code segment or equivalent to prevent simultaneous access to shared library functions that do not support concurrent use. Function hooking of the synchronization flag or equivalent, provided by a shared video synchronizer 610, can be used by all graphics functions, both those provided by the video drivers and those allowing direct invocation of video card commands, to synchronize commands to the graphics card. The synchronizer uses well known method of allowing single process access to shared resources, in this case the video card 168, to avoid conflicts between commands sent from separate sessions.

Additionally, the synchronizer 610 may be used to control

FIG. 6 shows an example of two sessions both using a single video card 168 having two output ports with synchronization of access to the video card. This figure is based on the shared libraries provided the Windows XP operating system from Microsoft Corp and/or the video board manufacturer. These libraries may include the Graphics Libraries 210 providing high level graphics commands, the DirectX libraries (DXG.SYS) 620, the Windows Kernel Mode Graphics Display Interface (Win32K.SYS) 630, the Video Driver DLL 640 and the kernel image library (NTOSKRNL.EXE) 650.

In FIG. 6 two users, User 1 (136) and User 2 (144) are using Session “1” and Session “2” executing in the same host 604 respectively. The applications they are using (148 and 176 respectively) are both using generating graphical output to be displayed using the same Video Card 168. The respective video processing in each session is coordinated through the use of Video Synchronizer 610 which may be executing in any session but will commonly be executing in Session “0”. The graphics rendering call stacks represented by the Graphics Libraries 210, DXG.SYS 620, Win32K.SYS 630, Video Driver DLL 640 and

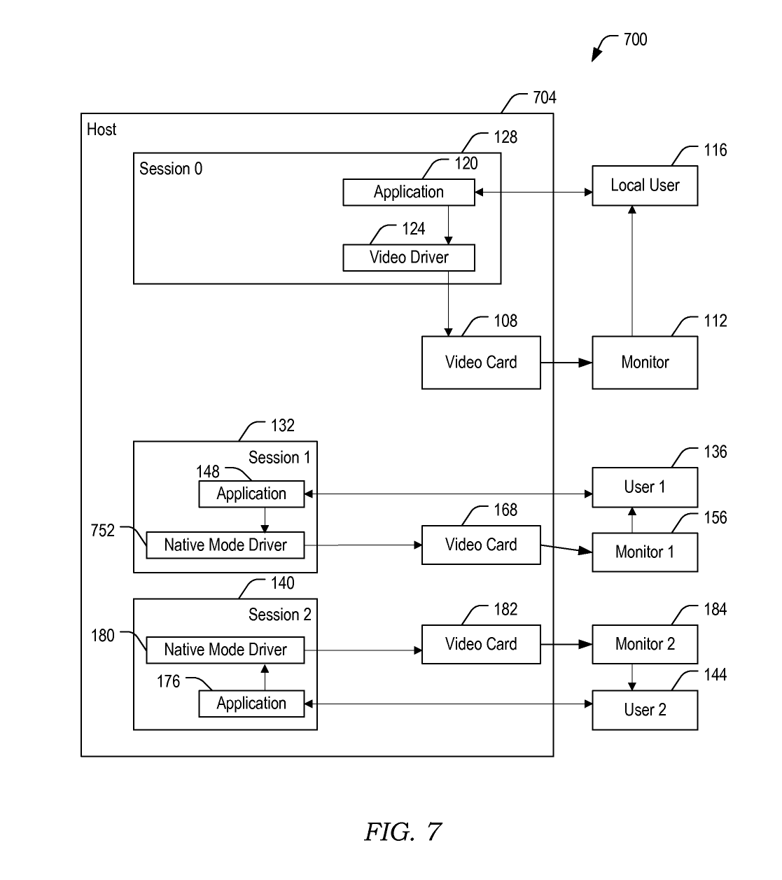

FIG. 7 is a block diagram 700 illustrating the use of multiple physical graphics cards with native drivers in a single host to support multiple sessions in accordance with one or more exemplary embodiments of the invention.

FIG. 7 shows an embodiment of this invention in which a single host 704 executes multiple sessions using multiple video cards (108, 168 and 182) to render video output for multiple users (116, 136, and 144) on a plurality of monitors (112, 156, and 144 respectively). In the depicted embodiments, tree such sessions are seen: session “0” (128), session “1” (132), and session “2” (140), however number of sessions may be two or more than three. When using native mode video drivers (752, and 180) to provide direct access from the sessions (session “1” (132) and session “2”

In this exemplary embodiment, session “0” (128) serves local user 116 as depicted in FIG. 2.

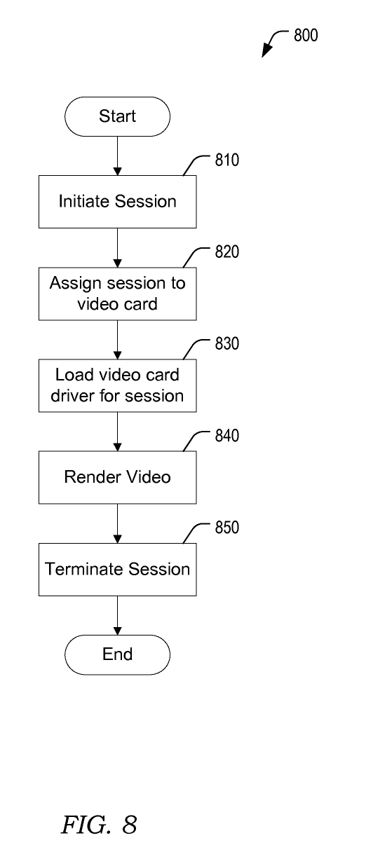

FIG. 8 is a flow diagram 800 illustrating the method of associating sessions and video cards using native mode video drivers in accordance with one or more exemplary embodiments of the invention.

FIG. 8 is a flow chart illustrating the steps used to associate the native mode video drivers in multiple sessions to the specific video cards.

When a new session is required the session is initiated in step 810. Initiation of a new session invokes commands to load a video driver. When the commands used to load a video driver are issues, a function hooking method redirects the execution of the commands to alternate executable code to assign the session to a video card in step 820, and in the case of multiple ports on the same video card, to a port on the video card. The process of replacing the normal session video driver with a native mode video driver is the subject of United States Provisional Patent Application 2009/0089815. Normally there is no requirement to map a specific session to a specific video card, as sessions will be created for all video cards configured for use, and since each session is mapped to a video card at initiation there is no history or persistent information associated with any specific session at the point at which the assignment

The correct video driver for the assigned video card is loaded in step 830. This associates output from all application executed in the session to the assigned video card presenting the user with an experience that matches the operation of a single PC and monitor to the single session seen by the user and the monitor attached to the video card and optionally the port associated with the session.

As the session is in use, the video output of the session is rendered to the video card and displayed on the monitor as indicated in step 840.

When the session is terminated in step 850 the association of the session to the video card, and optionally to the port, can be removed as no more video output will be generated by the session. At this time the process can be repeated with a new session to associate the new session with the video card and optionally the video port that was in use but is now no longer associated with a session.

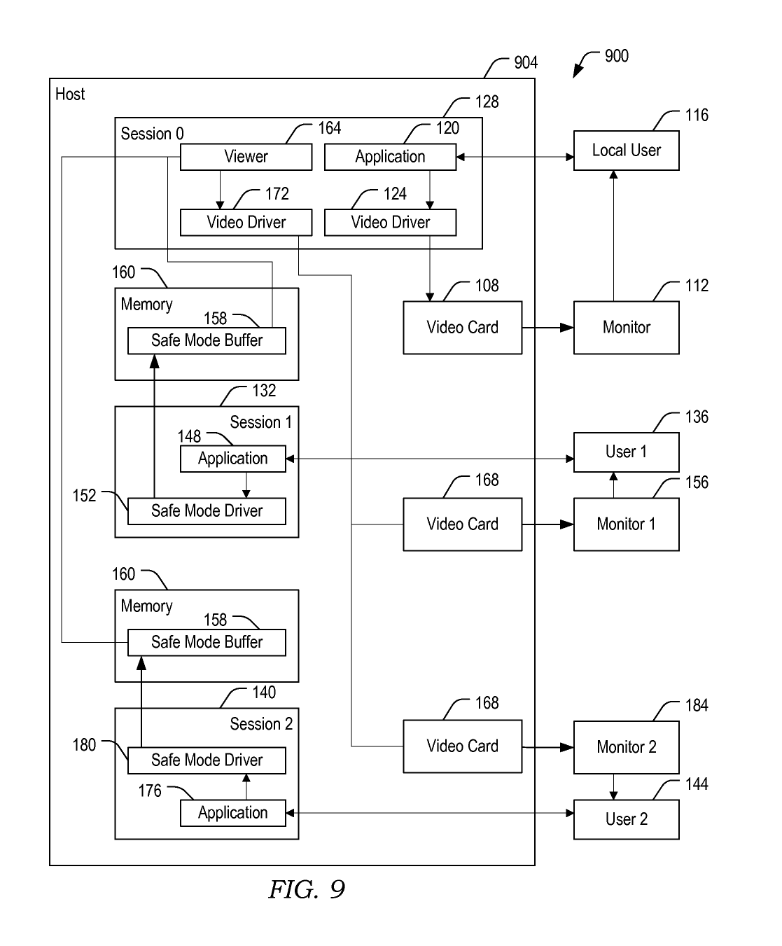

FIG. 9 is a block diagram 900 illustrating the use of multiple physical graphics cards 168 with safe mode drivers (152, and 180) in a single host 904 to support multiple sessions in accordance with one or more exemplary embodiments of the invention.

FIG. 9 shows an embodiment of this invention in which a single host 904 executes multiple sessions (128, 132 and 140) using multiple video cards (108, and two of 168) to render video output for multiple users (local user 116, user 1 (136), and user 2 (144) respectively). It should be noted that the number of users may be only two (local user and user 1) or more than three within the general scope of the current invention.

In the embodiment shown in FIG. 9 multiple safe mode drivers (152, and 180) are used to provide output using multiple video cards (the two video cards 168). In this situation, the outputs for each session (session “1” (132), and session “2” (140)), must be identified by the viewer application 164 executing in session “0” (128) in order to write the correct output for the session to the video card associated with that session. This is done by maintaining a mapping of sessions to video cards, and optionally the port on the video card. As the viewer application reads the video output from each safe mode buffer 158 in memory 160, it directs the video output to the video card associated with the session.

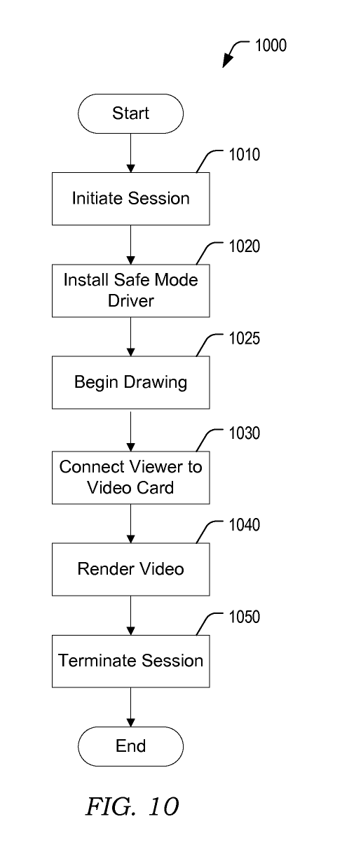

FIG. 10 is a flow chart 1000 illustrating the method of associating sessions and video cards using safe mode video drivers in accordance with one or more exemplary embodiments of the invention.

When a new session is required the session is initiated in step 1010. Initiation of a new session invokes commands to load safe video driver 1020. When the commands used to load a video driver are issues a function hooking method redirects the execution of the commands to alternate executable code to install a safe mode video driver. The process of replacing the normal session video driver with a safe mode video driver is the subject of United States Provisional Patent Application 2009/0089815. Normally there is no requirement to map a specific session to a specific video card as sessions will be created for all video cards configured for use and since each session is mapped to a video card at initiation there is no history or persistent information associated with any specific session at the point at which the assignment is made.

The correct video driver for the assigned video card is loaded in step 1020. This associates output from all application executed in the

After the video driver is installed in step 1020 the session may begin drawing graphical data in step 1025 and the Viewer application, 164 in FIG. 1 and others, is connected to the Video Driver used to communicate to the assigned video card used to show the graphical output of the session. The connection of the Viewer to the assigned video card is normally done by retrieving the identity of the video card associated with the session and may be done at any time after the installation of the safe mode driver in step 1020 and the rendering of video in step 1040.

As the session is in use, the video output of the session is rendered to the video card and displayed on the monitor as indicated in step 1040.

When the session is terminated in step 1050 the association of the session to the video card, and optionally to the port, can be removed as no more video output will be generated by the session. At this time the process can be repeated with a new session to associate the new session with the video card and optionally the video port that was in use but is now no longer associated with a session.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims. All publications, patents and patent applications mentioned in this

As used herein, the term “computer” or “module” may include any processor-based or microprocessor-based system including systems using microcontrollers, reduced instruction set computers (RISC), application specific integrated circuits (ASICs), logic circuits, and any other circuit or processor capable of executing the functions described herein. The above examples are exemplary only, and are thus not intended to limit in any way the definition and/or meaning of the term “computer”.

The computer or processor executes a set of instructions that are stored in one or more storage elements, in order to process input data. The storage elements may also store data or other information as desired or needed. The storage element may be in the form of an information source or a physical memory element within a processing machine.

The set of instructions may include various commands that instruct the computer or processor as a processing machine to perform specific operations such as the methods and processes of the various embodiments of the invention. The set of instructions may be in the form of a software program. The software may be in various forms such as system software or application software. Further, the software may be in the form of a collection of separate programs or modules, a program module within a larger program or a portion of a program module. The software also may include modular programming in the form of object

As used herein, the terms “software” and “firmware” are interchangeable, and include any computer program stored in memory for execution by a computer, including RAM memory, ROM memory, EPROM memory, EEPROM memory, and non-volatile RAM (NVRAM) memory. The above memory types are exemplary only, and are thus not limiting as to the types of memory usable for storage of a computer program.

It is to be understood that the above description is intended to be illustrative, and not restrictive. For example, the above-described embodiments (and/or aspects thereof) may be used in combination with each other. In addition, many modifications may be made to adapt a particular situation or material to the teachings of the various embodiments of the invention without departing from their scope. While the dimensions and types of materials described herein are intended to define the parameters of the various embodiments of the invention, the embodiments are by no means limiting and are exemplary embodiments. Many other embodiments will be apparent to those of skill in the art upon reviewing the above description. The scope of the various embodiments of the invention should, therefore, be determined with reference to the appended claims, along with the full scope of equivalents to which such claims are entitled. In the appended claims, the terms “including” and “in which” are used as the plain-English equivalents of the respective terms “comprising” and “wherein.” Moreover, in the following claims, the terms “first,” “second,” and “third,” etc. are used merely as labels, and are not intended to impose numerical requirements on their objects.

Further, the limitations of the following claims are not written in means-plus-function format and are not intended to be interpreted based on 35 U.S.C. §112, sixth paragraph, unless and until such claim limitations expressly use the phrase “means for” followed by a statement of function void of further structure.

This written description uses examples to disclose the various embodiments of the invention, including the best mode, and also to enable any person skilled in the art to practice the various embodiments of the invention, including making and using any devices or systems and performing any incorporated methods. The patentable scope of the various embodiments of the invention is defined by the claims, and may include other examples that occur to those skilled in the art. Such other examples are intended to be within the scope of the claims if the examples have structural elements that do not differ from the literal language of the claims, or if the examples include equivalent structural elements with insubstantial differences from the literal languages of the claims.

1. A computer system comprising:
a host computer capable of concurrently executing
at least a first session having a first application interacting with a first user and
a second session having a second application interacting with a second user; and
at least a first monitor displaying output of said first application and used by said first user, and
a second monitor displaying output of said second application and used by said second user, wherein
said host computer comprises:
at least a first video card, and
at least a first video output connected to said first monitor
and a second video output connected to said second monitor.

2. The computer system of claim 1 wherein said first session is the primary consol session.

3. The computer system of claim 2 wherein said first user is the local user.

4. The computer system of claim 1 wherein both said first video and said second video output are outputs of said first video card.

5. The computer system of claim 1 wherein said host computer further comprising a second video card, wherein:
said first video output is an output of said first video card, and
said second video output is an output of said second video card.

6. The computer system of claim 1 wherein:
said host computer is further capable of concurrently executing at least one additional session having an additional application interacting with an additional user; and
an additional monitor displaying output of said additional application and used by said additional user.

7. The computer system of claim 6 wherein:
at least one of said first and second sessions comprise a safe mode driver receiving graphic data and commands from said respective first or second application and storing video data in a safe mode buffer in said host computer; and
said first session comprises a viewer, receiving video data from said safe mode buffer; and communicating data to said second video card using a video driver.

8. The computer system of claim 2 wherein:
said second session comprises a safe mode driver receiving graphic data and commands from said a second application and storing video data in a safe mode buffer in said host computer; and
said first session comprises a viewer, receiving video data from said safe mode buffer; and communicating data to said second video card using a video driver.

9. The computer system of claim 7 wherein:
at least one of said first and second sessions comprise a native video driver receiving graphic data and commands from said

10. The computer system of claim 9 wherein:
said first session comprises a native video driver receiving graphic data and commands from said a first application and communicating data to said first video card.

11. The computer system of claim 6 wherein:
said second session comprises a safe mode driver receiving graphic data and commands from said a second application and storing video data in a first safe mode buffer in said host computer; and
said third session comprises a safe mode driver receiving graphic data and commands from said a third application and storing video data in a second safe mode buffer in said host computer; and
said first session comprises a viewer, receiving video data from said first safe mode buffer and said second safe mode buffer; and
communicating data to said second video card and said third video card respectively using a video driver.

12. The computer system of claim 4 wherein said host computer further comprising a video synchronizer used by all graphics functions and allowing direct invocation of video card commands to synchronize commands to said video card.

13. The computer system of claim 12 wherein each of said sessions is assigned with a unique video output such that video from each session is displayed on one of said displays.

14. The computer system of claim 13 wherein each of said video outputs is on a separate video card.

15. The computer system of claim 14 wherein at least two of said video outputs are on the same video card.
